(19) United States
(12) Patent Application Publication
(10) Pub. No.: US 2018/0260530 A1
(43) Pub. Date: Sep. 13, 2018

(54) Patient Monitoring System and Method For Location Indication Within a Care Environment

(71) Applicant: General Electric Company, Schenectady, NY (US)

(72) Inventors: Magnus Kall, Espoo (FI); Matthew Grubis, New Berlin, WI (US); Scott Fuller, Greendale, WI (US); Eliana Stein, Madison, WI (US); Stephen Treacy, Milwaukee, WI (US)

(73) Assignee: General Electric Company, Schenectady, NY (US)

(21) Appl. No.: 15/456,835

(22) Filed: Mar. 13, 2017

(51) Int. Cl. G06F 19/00

(52) U.S. Cl. CPC G06F 19/3406; G06F 19/3418

(57) ABSTRACT

A patient monitoring system includes patient identification transmitters that each transmit a patient identifier and clinician identification transmitters that each transmit a clinician identifier. Identification receivers are arranged in a care facility to receive patient identifiers and the clinician identifiers. A location tracking system determines a patient location within the care facility for each patient identification transmitter based on a location of receipt of the patient identifier, and determines a clinician location for each clinician identification transmitter based on the location of receipt of the clinician identifier. A mapping module is executable to receive the patient locations and the clinician locations, and locate the patient locations and the clinician locations on a map of the care facility. It then displays a patient location indicator for each patient location and a clinician location indicator for each clinician location on the map of the care facility.

### BACKGROUND

The present disclosure relates generally to medical devices and, more specifically, to medical monitoring devices for monitoring a patient's physiology and health status, especially wireless monitoring devices and systems.

In the field of medicine physicians often desire to continuously monitor multiple physiological characteristics of their patients. Oftentimes, such monitoring of multiple physiological characteristics involves the use of several separate monitoring devices simultaneously, such as a pulse oximeter, a blood pressure monitor, a heart monitor, a temperature monitor, etc. Many standard patient monitoring devices are large and bulky, tethering the patient to bedside devices via physical wiring or cabling that inhibits patient movement and requires a patient to stay in one location or transport a large monitor with them when they move from one place to another, and this discourages, rather than encourages, patient movement. Thus, continuous monitoring has the potential to conflict with treatment and recovery goals involving patient mobility, where patient activity is encouraged and requiring a patient to be active is recommended for expediting patient recovery. However, wireless monitoring devices have been developed that are relatively small devices that can be fixed to the patient, such as wearable devices. Such wireless monitoring devices allow patients to move around more freely, thus enabling continuous monitoring of multiple physiological characteristics without inhibiting patient movement and discouraging speedy recovery.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One embodiment of a patient monitoring system includes one or more patient identification transmitters that each transmit a patient identifier, wherein each patient identifier is associated with a patient. The patient monitoring system further includes one or more clinician identification transmitters that each transmit a clinician identifier associated with a clinician. A location tracking system has a plurality of identification receivers arranged in a care facility to receive the patient identifiers and the clinician identifiers. The location tracking system determines a patient location within the care facility for each patient identification transmitter based on a location of receipt of the patient identifier, and determines a clinician location for each clinician identification transmitter based on the location of receipt of the clinician identifier. The system further includes a mapping module executable to access a map of the care facility, receive the patient locations and the clinician locations, and locate the patient locations and the clinician locations on the map of the care facility. The mapping module is further executable to display a patient location indicator for each patient location and a clinician location indicator for each clinician location on the map of the care facility.

A method of patient monitoring includes transmitting a patient identifier associated with a patient from a patient identification transmitter, and transmitting a clinician identifier associated with a clinician from a clinician identification transmitter. The patient identifier is received at a first identification receiver at a first known location, and a patient location within a care facility is determined based on the first known location. The clinician identifier is received at a second identification receiver at a second known location, and a clinician location within a care facility is determined based on the second known location. A map of the care facility is accessed and the patient location and the clinician location are located on the map. The patient location indicator and a clinician location indicator are then each display on the map of the care facility.

Various other features, objects, and advantages of the invention will be made apparent from the following description taken together with the drawings.

### BRIEF DESCRIPTION OF THE DRAWINGS

The present disclosure is described with reference to the following Figures.

FIG. 1 is a schematic diagram of an exemplary patient monitoring system according to the present disclosure.

FIGS. 2A-2B depict embodiments of activity sensors connected to a patient as part of a patient monitoring system.

FIG. 3 is a schematic diagram of a computing system containing a mapping module as part of a patient monitoring system.

FIG. 4 is an exemplary embodiment of a display providing location indicators on a map of a care facility.

FIG. 5 is an exemplary embodiment of a display providing location indicators and a targeted alarm notification on a map of a care facility.

FIG. 6 is an exemplary embodiment of a display providing location indicators and a service route indicator on a map of a care facility.

FIGS. 7-8 depict various embodiments of patient monitoring and location indication within a care facility.

### DETAILED DESCRIPTION

Wireless monitoring systems are desirable for patient comfort, for example to provide more comfort and mobility to the patient being monitored. The patient's movement is not inhibited by wires between sensor devices and/or computing devices that collect and process the physiological data from the patient. Thus, small sensing devices and sensors that can be easily attached to the patient's body are desirable, such as sensing devices that are wearable portable computing devices. However, the inventors have recognized that wearable monitoring systems present certain new challenges due to the fact that patient movement is less inhibited and that tracking a patient's location may become more challenging. The inventors have further recognized that clinician's need a way to immediately locate patients within a care facility, especially as they become more mobile, and thus monitoring systems need to present patient location information in a way that is intuitively and immediately understood by clinician and others administering patient care.

The inventors have recognized that systems and methods are needed to track and efficiently provide information regarding the location of patients and clinicians, as well as other individuals, devices, etc., within a care facility. Thereby, a clinician can easily locate a patient at any time, such as if the patient experiences an alarm condition, or if the clinician simply needs to provide scheduled care. Further, information regarding the location of patients, clinicians, and devices at any given time within a care facility can be used for patient care planning and optimization. For example, information regarding the location of patients and clinicians in a care facility can be used to optimize the use of clinician resources, such as planning the most efficient route for treating patients and/or determining the best person to respond to an alarm condition. Moreover, patient location information can be used by a clinician in planning their care services, such as planning the order in which they see patients based on the patients' current location.

In view of the foregoing needs and challenges in the relevant field recognized by the inventors, the inventors have developed the presently disclosed patient monitoring system and method including a mapping module that provides visual location indication of patients, clinicians, and/or other people and devices within a care facility. Specifically, the systems and methods locate patients, clinicians, and/or devices with respect to a map of a care facility. For example, patient location indicators, clinician location indicators, device location indicators and visitor location indicators may be provided on a map of a care facility identifying the locations of each person and device within the relevant care facility, or care area.

In various examples, the map may be a floor plan or another type of plan view of a care facility. The care facility displayed on the map may be an entire hospital, or be a section, floor, unit, or any other portion of the hospital or other medical facility. Additionally, the system may include activity monitoring, such as measuring and determining an activity of a patient, and such information may also be provided by the respective location indicator. For example, the patient location indicator may indicate a patient's activity, such as laying, standing, walking, etc. Likewise, relevant physiological and/or medical information may be provided on the display, such as indicated by or in conjunction with the patient location indicator. For example, the patient location indicator may indicate heart rate information, such as whether the patient's heart rate is in the normal range, slightly elevated, or very elevated generating an alarm condition. Thereby, the map display can provide a holistic picture of what is going on in a care facility at any given time, and such information can be provided in a way that is intuitive and immediately ascertainable by a viewer.

Alternatively or additionally, the mapping module may be configured to identify and alert an optimal clinician to attend to a patient, such as to respond to an alarm condition, and the map display may be utilized to provide information to the clinician regarding the patient location and/or the best route from the responding clinician's current location to the patient's location. Similarly, where the mapping module tracks and locates devices within a care facility, such information may be used by the mapping module to determine and provide an optimal service route for identifying and locating devices within a care facility that are in need of service. For instance, the mapping module may receive a list of devices in need of battery replacement and may determine an optimal service route for efficiently locating the relevant devices in need of battery replacement.

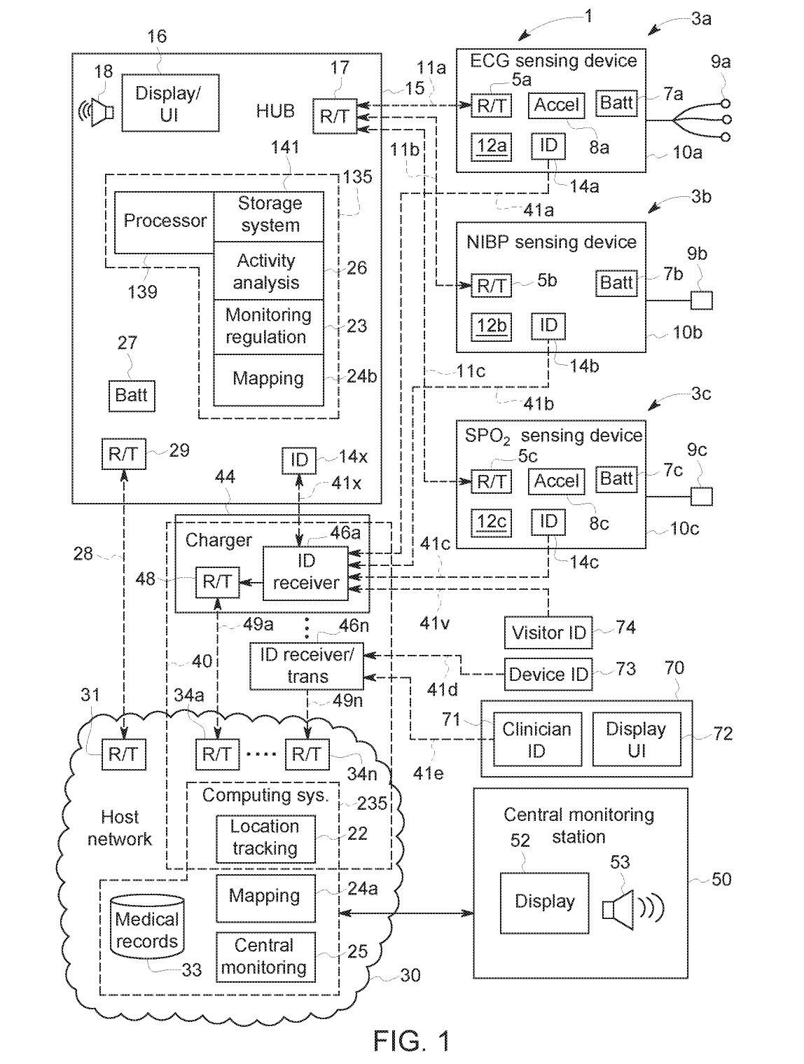

In various embodiments, a patient monitoring system 1 may include one or more wireless sensing devices (e.g. 3a-3c), each measuring different physiological parameter data from a patient. For example, the wireless sensing devices 3a-3c may be networked to a central hub or primary sensing device that determines a patient condition and regulates the various sensing devices in the network. In certain embodiments having a hub 15 (e.g. FIG. 1), the hub 15 may communicate with a central network for the medical care facility, e.g., host network 30. In another embodiment, the wireless sensing devices 3a-3c may communicate directly with the host network 30, which may coordinate and/or regulate the operation of the various sensing devices. It will be understood by a person having ordinary skill in the art that the monitoring and control methods discussed herein as being executed by the hub 15 may equally be executed by a host network 30. There, the wireless sensing devices may communicate with the host network 30 directly, or indirectly, through the hub. For example, the hub may serve as an amplifier and/or router for communication between the wireless sensing devices and the host network 30. In such embodiments, each sensing device 3a-3c may process its own physiological parameter data and determine its own alarming conditions or such functions may be performed at the level of the host network 30.

FIG. 1 depicts one embodiment of a patient monitoring system 1 containing three wireless sensing devices 3a-3c in wireless communication with a hub 15. The hub 15 is in wireless communication with a host network 30 that contains medical records database 33. For example, the hub device 15 may be attached to the patient's body, placed on or near the patient's bed, or positioned within range of the patient, such as in the same room as the patient. The hub device 15 may be a separate stand alone device, or it may be incorporated and/or housed with another device within the system 1, such as housed with one of the wireless sensing devices 3a-3c.

Each wireless sensing device 3a-3c contains one or more sensors 9a-9c for measuring physiological parameter data from a patient, and also includes a data acquisition device 10a-10c that receives the physiological parameter measurements from the sensors 9a-9c and transmits a parameter dataset based on those measurements to the hub device 15 via communication link 11a-11c. The sensors 9a-9c may be connected to the respective data acquisition device 10a-10c by wired or wireless means. The sensors 9a-9c may be any sensors, leads, or other devices available in the art for sensing or detecting physiological information from a patient, which may include but are not limited to electrodes, lead wires, or available physiological measurement devices such as pressure sensors, flow sensors, temperature sensors, blood pressure cuffs, pulse oximetry sensors, or the like. In the depicted embodiment, a first wireless sensing device 3a is an ECG sensing device having sensors 9a that are ECG electrodes. A second wireless sensing device 3b is a non-invasive blood pressure (NIBP) sensing device with a sensor 9b that is a blood pressure cuff including pressure sensors. A third wireless sensing device 3c is a peripheral oxygen saturation (SpO2) monitor having sensor 9c that is a pulse oximetry sensor, such as a standard pulse oximetry sensor configured for placement on a patient's fingertip. It should be understood that the patient monitoring system 1 of the present disclosure is not limited to the examples of sensing devices provided, but may be configured and employed to sense and monitor any physiological parameter of the patient. The examples provided herein are for the purposes of demonstrating the invention and should not be considered limiting.

The data acquisition device 10a-10c of each of the exemplary wireless sensing devices 3a-3c may include analog-to-digital (A/D) converters, which may be any devices or logic sets capable of digitizing analog physiological signals recorded by the associated sensors 9a-9c. For example, the A/D converters may be Analog Front End (AFE) devices. The data acquisition devices 10a-10c may further include processing units 12a-12c that receive the digital physiological data from the A/D converters and create physiological parameter data for transmission to the hub device 15 and/or to the host network 30. Each data acquisition device 10a-10c may be configured differently depending on the type of wireless sensing device, and may be configured to perform various signal processing functions and/or sensor control functions. To provide just a few examples, the processing unit 12a in the ECG sensing device 3a may be configured to filter the digital signal from the ECG sensors 9a to remove artifact and/or to perform various calculations and determinations based on the recorded cardiac data, such as heart rate, QRS interval, ST-T interval, or the like. The processing unit 12b in the NIBP monitor 3b may be configured, for example, to process the physiological data recorded by the sensors 9b in a blood pressure cuff to calculate systolic, diastolic, and mean blood pressure values for the patient. The processing unit 12c of the SpO2 sensing device 3c may be configured to determine a blood oxygenation value for the patient based on the digitized signal received from the pulse oximetry sensor 9c.

Accordingly, the processing unit 12a-12c may develop physiologic parameter data that, in addition to the recorded physiological data, also includes values measured and/or calculated from the recorded physiological data. The respective processing units 12a-12c may then control a receiver/transmitter 5a-5c in the relevant wireless sensing device 3a-3c to transmit the physiologic parameter data to the hub device 15 via communication link 11a-11c. The physiologic parameter data transmitted from the respective wireless sensing devices 3a-3c may include the raw digitized physiological data, filtered digitized physiological data, and/or processed data indicating information about the respective physiological parameter measured from the patient. Additionally, one or more of the data acquisition devices 10a-10c may be configured to compare the physiologic parameter data to one or more alarm thresholds to determine the presence of an alarm condition.

In other embodiments, the processing units 12a-12c may not perform any signal processing tasks and may simply be configured to perform necessary control functions for the respective wireless sensing device 3a-3c. In such an embodiment, the parameter data set transmitted by the respective processing unit 12a-12c may simply be the digitized raw data or digitized filter data from the various sensor devices 9a-9c.

The receiver/transmitter 5a-5c of each wireless sensing device 3a-3c communicates via the respective communication link 11a-11c with the receiver/transmitter 17 of the hub device 15, which may include separate receiving and transmitting devices or may include an integrated device providing both functions, such as a transceiver. The receiver/transmitters 5a-5c of the wireless sensing devices 3a-3c and the receiver/transmitter 17 of the hub device 15 may be any radio frequency devices known in the art for wirelessly transmitting data between two points. In one embodiment, the receiver/transmitters 5a-5c and 17 may be body area network (BAN) devices, such as medical body area network (MBAN) devices, that operate as a wireless network. For example, the wireless sensing devices 3a-3c may be wearable or portable computing devices in communication with a hub device 15 positioned in proximity of the patient. Other examples of radio protocols that could be used for this purpose include, but are not limited to, Bluetooth, Bluetooth Low Energy (BLE), ANT, and ZigBee.

In various embodiments, one or all of the sensing devices 3a-3c may be equipped with a patient identification transmitter 14a-14c that emits a patient identifier 61 that is detected by a location tracking system 40. The location tracking system 40 receives the patient identifier 61 in order to determine the patient's location. The location tracking system 40 may be, for example, a real-time location system (RTLS) that provides immediate or real time tracking of the patient's location. In the embodiment of FIG. 1, each sensing device 3a-3c includes a patient identification transmitter 14a-14c that transmits a patient identifier 61 associated with the patient. Since the sensing devices 3a-3c are body-worn devices, the patient identification transmitter(s) 14 can be used to determine a patient location within the care facility.

A plurality of identification receivers 46a-46n are placed at known locations throughout a care facility. The identifier transmitted by the patient identification transmitter 14a-14c is received by one of the identification receivers 46a-46n closest to, or otherwise arranged to receive transmissions from, identification transmitters at that particular location of the patient. Each identification receiver 46a-46n then communicates the patient identifier 61, along with its own receiver identification, to a location tracking module 22 that monitors and determines the patient location for the location tracking system 40 within the care facility. For example, the identification receiver 46a, 46n may communicate the patient identifier 61 and its own identification with a host network 30 for the care facility.

The location tracking module 22 then determines a patient location 68 based on which identification receiver 46a-46n receives the identifier for that patient from one or more of the identification transmitters 14a-14c. Specifically, the location tracking module 22 accesses a map or database of the care facility where each identification receiver 46a-46n is associated with a particular location in the care facility. The map associating each identification receiver 46a-46n with a location in the care facility may be, for example, uploaded and stored in the computing system 235 of the host network 30 as part of the system configuration.

The location tracking system 40 may further be configured to track the locations of various other individuals and devices within a care facility. Various individuals occupying a care facility may have identification transmitters transmitting an identifier that is associated to them, or at least to their role in the care facility. Referring to FIG. 1, a visitor in a care facility may have a visitor identification transmitter 74 that transmits a visitor identifier identifying them as a visitor to the location tracking system 40. The visitor identification transmitter 74 transmits the visitor identifier via communication link 41v to a respective identification receiver 46a, 46n of the location tracking system 40. As described above, such communication may be by any of various wireless means depending on the configuration of the location tracking system 40.

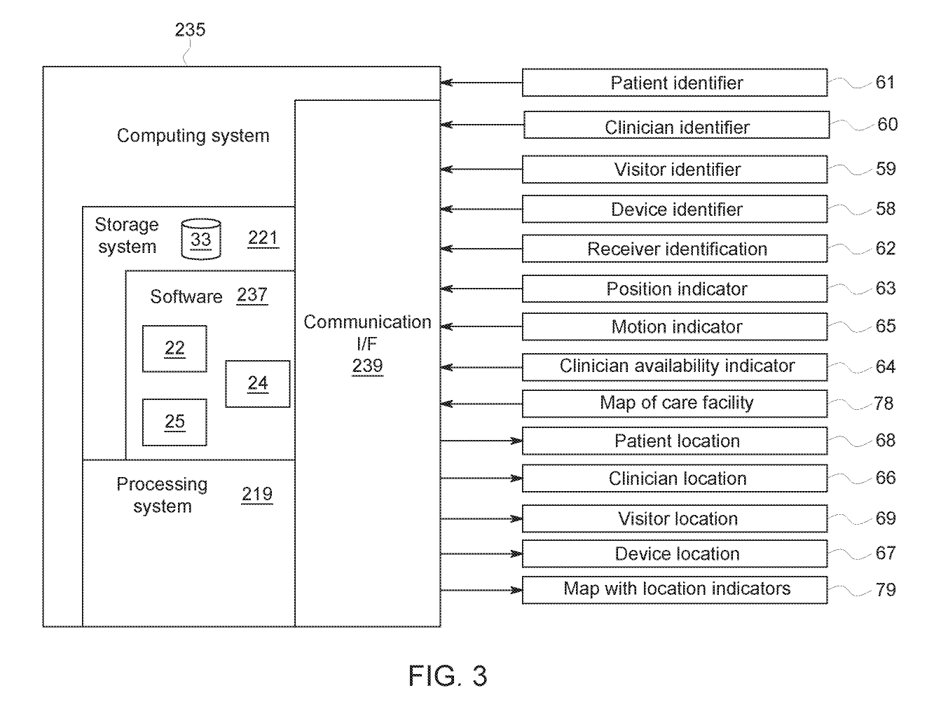

Similarly, clinicians may also carry an identification transmitter. For example, each clinician may have an identification transmitter corresponding to their role in patient care, such as nurses carrying nurse location transmitters that transmit a nurse identifier, physicians carrying physician location transmitters that transmit a clinician identifier, etc. Alternatively, each clinician may carry a location transmitter that transmits an identifier associated with and identifying that individual clinician within the location tracking system 40. In the example of FIG. 1, the system 1 includes at least one clinician identification transmitter 71 incorporated in a clinician device 70, which for example may be a handheld or wearable device. The clinician identification transmitter 71 transmits a clinician identifier 60 (e.g., a nurse identifier, physician identifier, individualized clinician identifier, or the like) via communication link 41e to a respective identification receiver 46a, 46n of the location tracking system 40. As described above, such communication may be by any of various wireless means depending on the configuration of the location tracking system 40. The location tracking system 40 then generates a clinician location 66 (FIG. 3) based on the location of the receiver 46a, 46n that receives the clinician identifier 60.

The clinician device 70 also includes a user interface display 72 that displays information to the clinician and receives input from the clinician. The user interface display 72 includes any type of display device appropriate for a portable, handheld or wearable device, which may be a touch screen or may include an associated user input means, such as touch and/or voice input means. For example, the user interface display 72 may be utilized for a clinician to control and availability mode or clinician availability indicator 64 that indicates their availability to treat a patient and/or to respond to an alarm condition, or the like. In certain embodiments, the clinician availability indicator 64 may be used by the mapping module 24 in combination with the clinician location 66 to determine the best clinician to respond to a patient need and/or an alarm condition.

In the example of FIG. 1, the system 1 also includes at least one device identification transmitter 73 (which for example may be a transmitter attached to or incorporated into any device device) that transmits a device identifier 58 via communication link 41d to a respective identification receiver 46a, 46n of the location tracking system 40. As described above, such communication may be by any of various wireless means depending on the configuration of the location tracking system 40. The location tracking system 40 then generates a device location 67 based on the location of the receiver 46a, 46n that receives the device identifier 58.

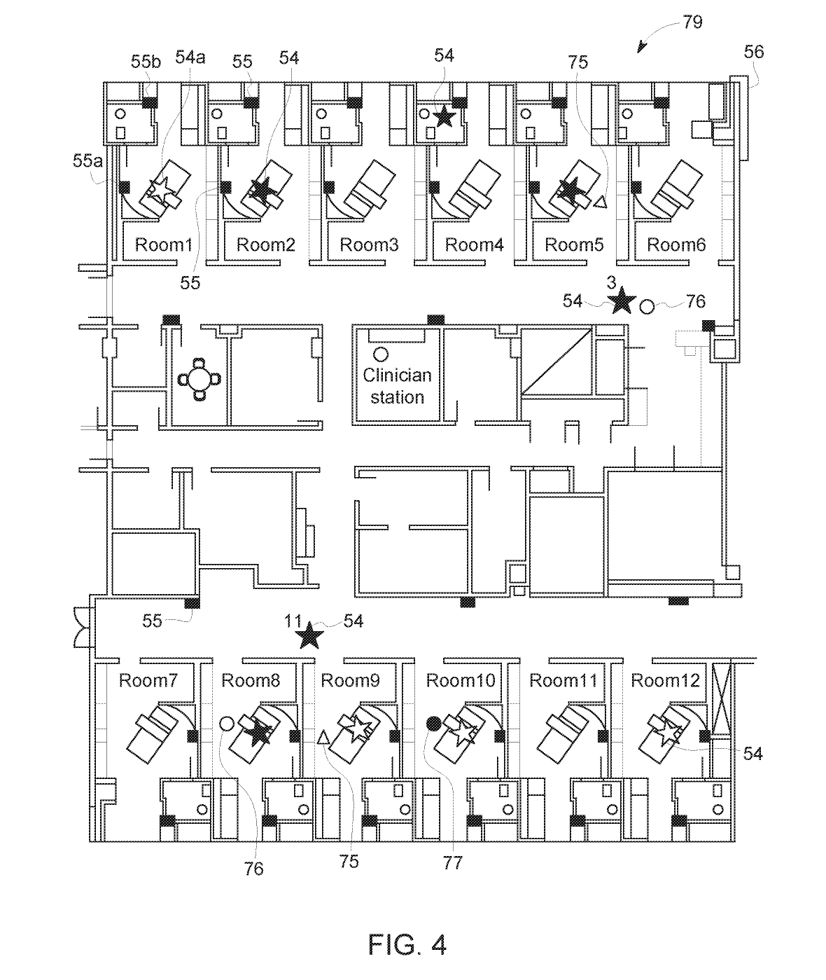

The mapping module 24 receives the patient location 68, visitor location 69, clinician location 66, and/or device location 67 and locates each received location on a map 78 of the care facility. The mapping module 24 then generates location indicators for each location 67-69. As further described herein, the location indicators may also provide additional information about the person or device being indicated. For example, the patient location indicator indicating the patient location 68 on the map 78 may further indicate information regarding the patient's physiological condition and/or the activity of the patient. The clinician location indicator indicating a clinician location 66 may further provide information about the availability of the clinician, such as based on the availability indicator 64 set by the respective clinician via the clinician device 70. For example, the clinician location indicator may, in addition to locating the clinician on the map of the care facility, indicate whether the respective clinician is available to respond to a patient request and/or to a patient experiencing an alarm condition. Similarly, the device location indicator indicates the device location(s) 67 on the map 78, and may further indicate information about the respective devices, such as whether the device needs service, battery replacement, etc. The visitor location identifier identifies visitor location(s) on the map 78, and may further provide information regarding who the visitor is and/or which patient the visitor is associated with. The locations of the various patients, clinicians, visitors, and devices can then be located on the map 78 of the care facility, such as on the exemplary user interface display graphic 56 of FIG. 4. Thereby, a single graphical depiction presents the locations of all individuals within a care facility, or within an area of a care facility.

FIG. 4 exemplifies a user interface display graphic 56 that might be shown on a display 52 of a central monitoring station 50 or on a display 72 of a clinician device 70. The map 78 of the care facility is overlaid with multiple location indicators 54-55, 75-77 showing the locations of various individuals and devices within the depicted care facility. patient location indicators 54 (including 54a, etc.) illustrate the current, or last measured, patient location determined by the location tracking system 40 for each tracked patient. Accordingly, the user interface display graphic 56 illustrates the patient locations of multiple patients in a particular care facility. In certain embodiments described in more detail below, the patient location indicators 54 may also convey information about a patient's activity, such as a patient's position and/or motion.

In the exemplary user interface display graphic 56 shown in FIG. 4, the display graphic 56 shows the assigned locations of multiple identification receivers 46 (including device location indicators 55a, 55b, etc.) within a particular care facility area. For example, one or more identification receivers 46 are provided in each patient room and multiple identification receivers 46 are located in the hallways, each of which is indicated on the display graphic 56 by a device location indicator 55. Additionally, the user interface display graphic 56 may display one or more location indicators of other individuals, such as a visitor location indicator 75, nurse location indicator 76, and a physician location indicator 77.

In certain embodiments, the sensing devices 3a-3c my coordinate their transmission of the patient identifier by the identification transmitters 14a-14c so that the transmissions are spaced out in time. Thereby, the identifier can be transmitted more frequently and redundancy between the sensing devices 3a-3c can be reduced. Such coordination provides an efficient use of resources, including battery power, because it limits the frequency (interval) at which each sensing device transmits the patient identifier. In other embodiments, the identification transmitters 14a-14c may independently and/or simultaneously transmit the patient identifier, which may be used to provide redundancy and certainty to the patient location determination. In certain embodiments, the patient identifier transmitted by the identification transmitters 14a-14c may be identical to one another, or may be different patient identifiers that are each associated with the patient.

The hub 15 may also include a patient identification transmitter 14x that transmits a location of the hub 15. Such patient identification transmitter 14x in the hub 15 may be in lieu of or in addition to the identification transmitters 14a-14c in the sensing devices. In embodiments where the hub 15 is a small, body-worn device that is attached to the patient, the patient identification transmitter 14x in the hub 15 may be sufficient for patient location tracking purposes. In embodiments where the hub 15 is not a body-worn device, the patient identification transmitter 14x may be unreliable, by itself, for patient location tracking. In such embodiments, the patient identification transmitter 14x may be used for tracking the location of the hub 15 separately from the patient.

Identification receivers 46 may be provided at fixed locations throughout the care facility, such as at each room, bed, bay, hallway, etc. to enable tracking the patient's location throughout the care facility. Each patient 4 and their associated wireless monitoring system may be assigned a primary identification receiver 46. For example, the primary identification receiver (e.g., 46a) may be located at the location where the patient is likely to spend the most time, such as the patient's assigned room, bed, bay, etc. For example, each patient room may be equipped with an identification receiver 46 dedicated to that room, which may then be associated to the patient when the patient 4 is assigned to that room. Any patient identifier received by the primary identification receiver 46a is assumed to indicate that the patient is located in their assigned room.

In certain embodiments, each patient room may be equipped with multiple identification receivers 46 which may provide detailed information about the patient's location within their room. In such an embodiment, one of the identification receivers 46 may be identified as the primary identification receiver (e.g. 46a) which, for example, may be associated with the patient's bed. In the exemplary scenario shown in FIG. 4, each patient room has two identification receivers 46. The primary identification receiver (e.g. 46a for the patient 54a assigned to room one) receives the patient identifier when the patient is in their bed or in the main part of their room. A second identification receiver (e.g. 46b) is located in the bathroom of the patient's room. Thus, the location tracking system 40 can identify when the patient 54a goes into the bathroom of their assigned room, namely when the patient identifier is received by the identification receiver 46b in the patient's bathroom. Such information may be important for tracking the patient's bathroom activity, and/or for finding the patient quickly should an alarm condition occur.

In certain embodiments, the primary identification receiver 46a (e.g., device location indicator 55a for patient 54a) may be provided in a charger 44 associated with the monitoring system, such as associated with one or more of the sensing devices 3a-3c. As the charger 44 is likely a device that remains plugged in to a power source, such as a wall outlet, the charger 44 is not a portable device and thus remains at a relative fixed location during a monitoring period. For example, the charger 44 may remain plugged in to a wall outlet in a patient's room, or otherwise remain plugged into a particular power source. Thus the charger 44 remains at a relative fixed and known location—e.g., movement of the charger 44 is restricted by the length of the power cord connecting it to the power source. Accordingly, the charger 44 provides a reliable fixed and known location for placement of the identification receiver in a patient's room.

For example, each sensing device 3a-3c may have a battery 7a-7c that is charged by the respective charger 44. The battery 7a-7c may be a removable battery that can be removed from the respective sensing device 3a-3c and placed on the charger 44 for charging, and a replacement battery may be inserted into the respective sensing device 3a-3c. For example, all of the sensing devices 3a-3c may utilize identical batteries 7a-7c, and thus the charger 44 may provide a bank of charging slots where batteries can be swapped and charged as each sensing device requires. Alternatively, the charger 44 may be configured to connect to each respective sensing device 3a-3c in order to charge the respective batteries 7a-7c. Likewise, the charger 44 may be configured to charge a battery 27 of the hub 15.

The patient identification transmitters 14a-14c, 14x communicate with one of a plurality of identification receivers 46a, 46n via a respective communication link 41a-41c, 41x. The communication link 41a-41c, 41x may be by any of various wireless communication protocols and/or platforms, such as Bluetooth, Bluetooth Low Energy (BLE), ZigBee, Wi-Fi, infrared, ultrasound, or by other wireless communication means. In certain embodiments, it is preferable that the transmission range of the patient identifier be limited so that the patient identification transmitters 14a-14c, 14x are only within communication range of one identification receiver 46a-46n at a time. Thus, it may also be beneficial if the system is configured such that the communication signals and protocols do not pass through walls or other structural barriers so that identification receivers 46a, 46n can be placed in adjacent rooms, such as adjacent hospital rooms, without concern of cross-receiving. Accordingly, infrared may provide a good means for the communication links 41a-41c, 41x in other embodiments where line-of-sight limitations are prohibitive, other relatively short-range protocols may be desirable, such as Bluetooth, Bluetooth Low Energy (BLE), or ZigBee, or the like.

The identification receiver 46a, 46n may communicate with the host network via a separate receiver/transmitter (e.g. 48) that communicates with a respective receiver/transmitter 34 associated with the host network 30. Alternatively, one or more of the identification receivers 46a-46n may have a transmitter incorporated therein capable of transmitting the patient identifier and its own receiver identifier to a respective receiver/transmitter 34n associated with the host network 30. The patient identifier is communicated to the host network 30 via a respective communication link 49a-49n, which may be by any wireless or wired means and according to any communication protocol. For example, communication may be via a Wi-Fi network for the care facility, or by a dedicated wireless network for the location tracking system 40. For example, in certain embodiments the location tracking system 40 may employ one or more wireless local area networks (WLANs) situated throughout a care facility. In other embodiments, the devices on the location tracking system 40 may utilize the (WMTS) spectrum.

In certain embodiments, the patient identification transmitter 14a-14c, 14x may be incorporated into the receiver/transmitter 5a-5c, 17 associated with the respective sensing device 3a-3c and/or hub 15. In such an embodiment, the patient identifier may be transmitted by the respective receiver/transmitter 5a-5c, 17, such as on the same network as the physiologic parameter data. For example, in an embodiment where the sensing devices 3a-3c communicate directly to a host network 30, the patient identifier may be transmitted in conjunction with the physiological parameter data, which are received at a receiver associated with the host network 30, wherein the receiver is at a known location in the care facility.

In the embodiment depicted in FIG. 1, the identification transmitters are provided in the sensing devices 3a-3c and/or the hub 15 with the identification receivers 46a-46n provided at fixed and known locations throughout the care facility. In other embodiments, the identification receivers 46a-46n may travel with the tracked patient, clinician, device, etc. (such as provided in the sensing devices 3a-3c and/or the hub 15, and in the clinician device 70), and the patient identification transmitters 14 may be provided at fixed locations throughout the care facility. In such an embodiment, the respective sensing devices 3a-3c or hub 15 would receive the patient identifier from a nearby patient identification transmitter 14 and may be equipped to determine its own location based on the patient identifier received.

The location tracking module 22 is configured to receive the patient identifier 61 associated with the patient as well as the identification of the receiver 46a, 46n that received that patient identifier for the patient. Based thereon, the location tracking module 22 determines a patient location within a care facility. The location tracking module 22 is configured with the map 78 of the care facility, where a location of each identification receiver 46a-46n is associated to a location on the map 78 (e.g., illustrated by the device location indicators 55 in the display graphic 56). Thus, when a patient identifier 61 is received at a particular identification receiver 46a, 46n, the location tracking module 22 determines the patient location 68 for the patient associated with the patient identifier 61 to be a given location range on the map of the care facility associated with the identification receiver 46a, 46n that received the patient identifier. For example, the patient location may be determined to be the patient room associated with the identification receiver 46a assigned to or associated with that room.

As a patient moves throughout a care facility, the identifier transmitted by the patient identification transmitters 14a-14c, 14x associated with the patient are received by different identification receivers 46a, 46n, and the location tracking module 22 may update the patient's location as a new identification receiver 46a, 46n reports receiving the identifier. Further, the location tracking module 22 may store the patient location in order to track and store the patient's location over time. For example, a location pattern may be stored and generated for a patient's stay at a particular care facility. Additionally, the location tracking module 22 (and/or the mapping module 24) may consider the recent location pattern and/or the patient's activity information to identify a direction and/or speed of travel in order estimate a more exact location for the patient 4 within the range of the respective identification receiver 46.

The hub device 15 may further include a display 16 and a speaker 18 that may be used to generate an alert or alarm and/or to display information regarding the patient's location, activity, physiological condition, etc. The display 16 may be any type of digitally-controlled visual display, and may further be a touchscreen controllable by a user to provide input to the hub 15, such as to silence an alert or alarm.

The hub device may further include computing system 135 having processor 139 and storage system 141. The hub device 15 may serve to control the wireless sensing devices 3a-3c, and thus may transmit operation commands to the respective wireless sensing devices 3a-3c via the communication link 11a-11c to control their monitoring operations. The hub 15 may contain a monitoring regulation module 23 that is a set of software instructions stored in memory and executable on the processor to assess the physiologic parameter data collected by the wireless sensing devices 3a-3c and determine a patient condition therefrom, and to control the respective wireless sensing devices 3a-3c according to the patient condition. For example, the patient condition may be determined by comparing the physiologic parameter data collected by one or more of the sensing devices 3a-3c with alarm limits to determine whether the patient condition requires generating an alarm to alert the clinician to the patient's condition.

A mapping module 24 receives the patient location 68 (FIG. 3), such as from the location tracking module 22, and determines a patient location indicator 54 with respect to the map 78 of the care facility. The map 79 containing the patient location indicator(s) 54 is then outputted and displayed on one ore more displays 52, 72 comprising part of the system 1 (e.g. the exemplary user interface display graphic 56 of FIG. 4). For example, the map 79 with location indicators 54-55, 75-77 may be generated at a central monitoring station 50, such as may be provided at a nurses' station or other central location where clinicians can be accessed. The central monitoring station 50 includes a display 52 and speaker 53, each of which may selectively be used to generate a map with location indicators according to instructions by the mapping module 24.

In certain embodiments, the patient location indicator 54 may further be based on information from one or more activity sensors 8 attached to the patient and measuring the patient's position and/or motion. In the depicted embodiment, the hub 15 contains an activity analysis module 26 that receives information from one or more activity sensors 8 attached to the patient. With reference to the exemplary embodiment of FIG. 1, the ECG sensing device 3a and the SPO2 sensing device 3c each contain an activity sensor 8a, 8c that monitors a position and/or motion of the respective data acquisition unit 10a, 10c, which is attached at a location on the patient's body. In one exemplary embodiment, the activity sensor 8a-8c may include an accelerometer, such as a three-axis accelerometer, a gyroscope, such as a three-axis gyroscope, or a combination accelerometer/gyroscope sensor. In still other embodiments, the activity sensor(s) 8a-8c may be another type of inertial sensor, such as including a magnetometer and/or any other type of sensor capable of acting as an accelerometer and/or a gyroscope.

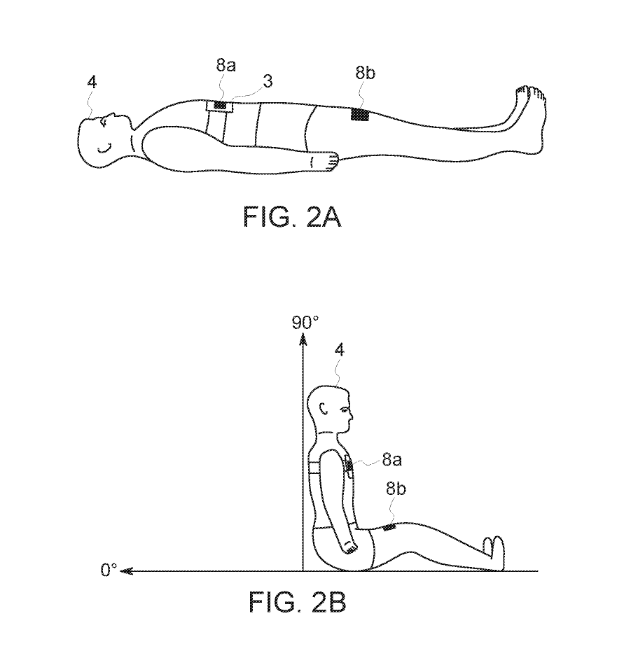

The activity sensors 8a-8c may be incorporated into the various sensing devices 3a-3c attached at various locations on the patient's body, or one or more activity sensors 8 may be stand alone devices attached at locations on the patient 4. FIGS. 2A and 2B illustrate an exemplary embodiment where one accelerometer 8a is incorporated into a sensing device 3 strapped to the patient's chest, which may be, for example, an ECG sensing device 3a. A second activity sensor 8b is attached to the patient's thigh. For example, the depicted arrangement of activity sensors 8a and 8b on the patient's torso and legs can be used to differentiate between a supine, seated upright, and standing position. For example, when the patient 4 is in the supine and standing positions both the activity sensors 8a and 8b will read the approximate orientation as one another—i.e. either both reading that the patient is lying horizontal or is standing vertically. However, when the patient is in the seated position as exemplified in FIG. 2B, the activity sensor 8a attached to the patient's chest will provide a different orientation than the activity sensor 8b attached to the patient's leg. Additionally, the depicted activity sensor 8a, 8b arrangement can also be arranged to sense information about the patient's motion, such as whether the patient is walking, where significant orientation changes would be detected in the activity sensor 8b on the patient's leg with lesser acceleration and/orientation changes measured by the activity sensor 8a on the patient's chest.

The activity information may be received by the activity analysis module 26 in the hub device 15, such as transmitted via the respective communication link 11a-11c between the sensing devices 3a-3c and the hub 15. The activity analysis module 26 determines at least one of a position indicator 63 and a motion indicator 65 (FIG. 3) based on the information received from the activity sensor 8a-8c. For example, the position indicator 63 may indicate one of a predetermined set of positions for the patient. For instance, the activity analysis module 26 may select the position indicator 63 from a predefined list of positions, including supine, reclined, seated upright, standing upright, kneeling, bent forward, or the like. Alternatively or additionally, the activity analysis module 26 may determine a motion indicator 65 based on information from the activity sensors 8a-8c. The motion indicator 65 may be, for example, one of a predefined list of motion, including slow walking, fast walking, running, jumping, stair climbing, stationary with arm motion, stationary with leg motion, or the like. The position indicator 63 and/or motion indicator 65 may then be used by the mapping module 24 to determine the patient location indicator 54. For example, the patient location indicator 54 may take into account the patient location 68 to provide context for interpreting the position indicator 63 and/or motion indicator 65. For example, recorded arm motion or leg motion may be interpreted differently, and thus a different patient location indicator 54 generated, depending on whether the patient location 68 is in the patient's bed versus in physical therapy.

Referring to the exemplary user interface display graphic 56 shown in FIG. 4, the position indicator(s) 63 and/or motion indicator(s) 65 for each patient may be reflected in the respective patient location indicators 54. For example, the patient location indicator 54 may be provided in a particular shape, color, pattern, or by other visualization to indicate the patient's activity, such as the patient's position and/or motion. In the depicted embodiment, patients that are sitting or standing upright are illustrated by a solid patient location indicator 54 and patients that are reclined or laying down are shown with a hollow patient location indicator 54. In other embodiments, more detailed information may also be provided regarding the patient's activity, such as regarding the patient's motion. For example, in another embodiment the patient location indicator 54 could be a stick figure indicating the patient's position and/or motion.

Additionally, the patient location indicator 54 may identify the particular patient 4 it represents, such as by indicating the patient's assigned room number, patient medical record number, name, pseudonym, or the like. In the example of FIG. 4, the patient location indicator 54 provides a patient identifier for any patient that is not in their assigned room (where their identity can be assumed from their location on the map 79). In the example, the identifier is the patient's assigned room number, which is provided immediately adjacent to the graphic representing the patient. Thereby, a clinician viewing the user interface display graphic 56 can immediately identify who each patient is according to their assigned room number. This allows maintenance of patient confidential information by avoiding use of patient name or other identification information if the display graphic were provided in a space that could be viewed by passersby, for example.

Alternatively or additionally, the mapping module 24 may further account for physiological information recorded by one or more of the sensing devices 3a-3c. For example, the mapping module 24 may account for the patient's heart rate and/or breath rate when determining the patient location indicator 54. In an example of such an embodiment, the patient location indicator 54 may be colored or shaped to indicate whether the patient's hear rate (or other physiologic parameter data) is within the low, normal, or high range. In other embodiments, the patient's heart rate may be indicated on or adjacent to the patient location indicator 54. Moreover, the mapping module 24 may further operate to instruct certain measurement modes for one or more of the sensing devices 3a-3c, such as instructing operation of the sensing devices to provide the physiological parameter data necessary to determine the patient location indicator 54. For instance, the ECG sensing device 3a may be instructed to prioritize a heart rate determination in noisy conditions when the patient is in motion and to cease or modify its recordation of ECG, such as reducing from a full twelve lead ECG recording to a three lead ECG recording.

Moreover, in certain embodiments, the clinician location indicator, such as the nurse location indicator 76 and/or physician location indicator 77, may further provide or indicate an availability status of the clinician, such as determined based on the clinician availability indicator 64. For example, the clinician location indicators 76, 77 of clinicians that are available, such as available to respond to an alarm condition and/or available to treat a patient, may appear larger or in a different color than the clinician location indicators 76, 77 of clinicians who have designated that they are unavailable. Alternatively, the map 79 may only provide clinician location indicators 76, 77 for clinicians that are available (e.g., according to their availability indicator 64), and unavailable clinicians may not appear on the map at all.

In certain embodiments, the mapping module 24 may be further executable to identify the best clinician to respond to a particular event, such as a patient alarm condition or a patient request. For example, the mapping module 24 may receive the patient location 68 of a patient experiencing an alarm condition or requesting that a clinician visit them. Depending on the nature of the event, the mapping module 24 may identify one or more clinicians, such as a nurse or a doctor or both, to respond to the event. The mapping module 24 may then notify the identified clinician(s), the responding clinician(s), such as by sending a targeted notification to the clinician device 70 associated with each responding clinician. For example, the targeted alarm notification may provide notification to the responding clinician of the event, such as a patient experiencing an alarm condition, as well as providing information to the clinician necessary for the clinician to locate the respective patient.

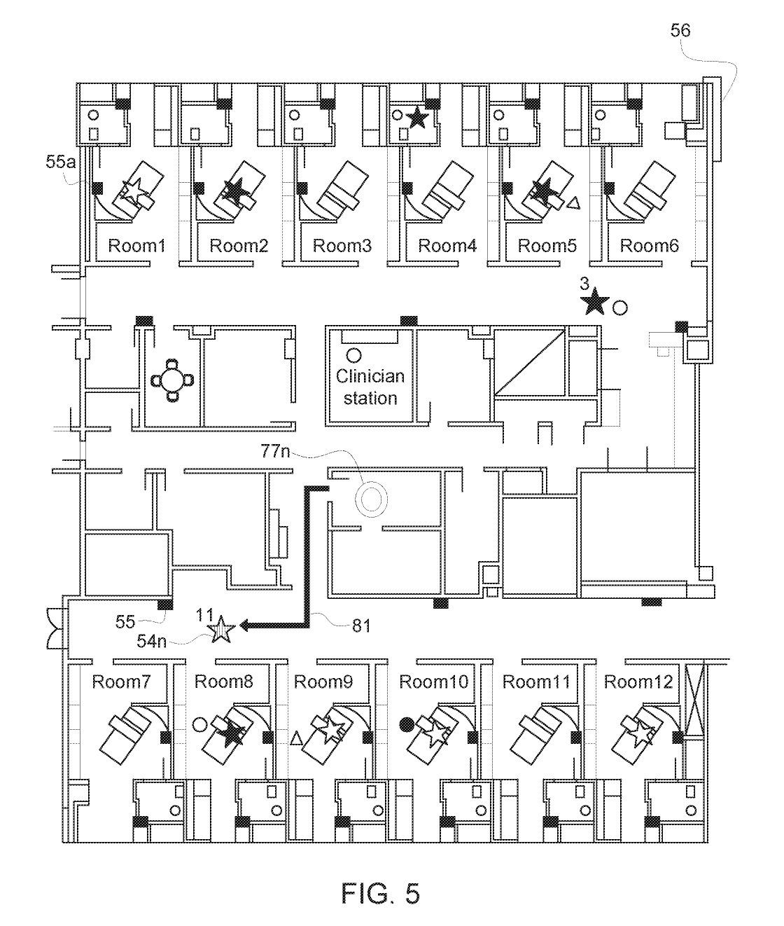

FIG. 5 provides one illustrative example of a targeted alarm notification. In the depicted embodiment, the targeted alarm notification includes a user interface display graphic 56 highlighting the patient location indicator 54n of the patient experiencing an alarm condition. The respective patient location indicator 54n is enlarged and shown in red so that the responding clinician can immediately identify the location of the troubled patient. Additionally, the user interface display graphic 56 provides a response route 81 between the clinician location identifier 77n and the patient location identifier 54n. Thereby, the targeted alarm notification provides specific and easy to follow guidance to the clinician on how to locate the patient. In other embodiments, the targeted alarm notification may take other forms. For example, the clinician device 70 may provide auditory, turn by turn instructions to the clinician on how to reach the patient. This frees up the display 72 of the clinician device 70 for providing other information on the user interface, such as information regarding the patient's medical record and/or alarm condition. In still other embodiments, the targeted alarm notification may take any graphical or auditory form that notifies the responding clinician of the patient need or alarm condition and their designation as the responding clinician.

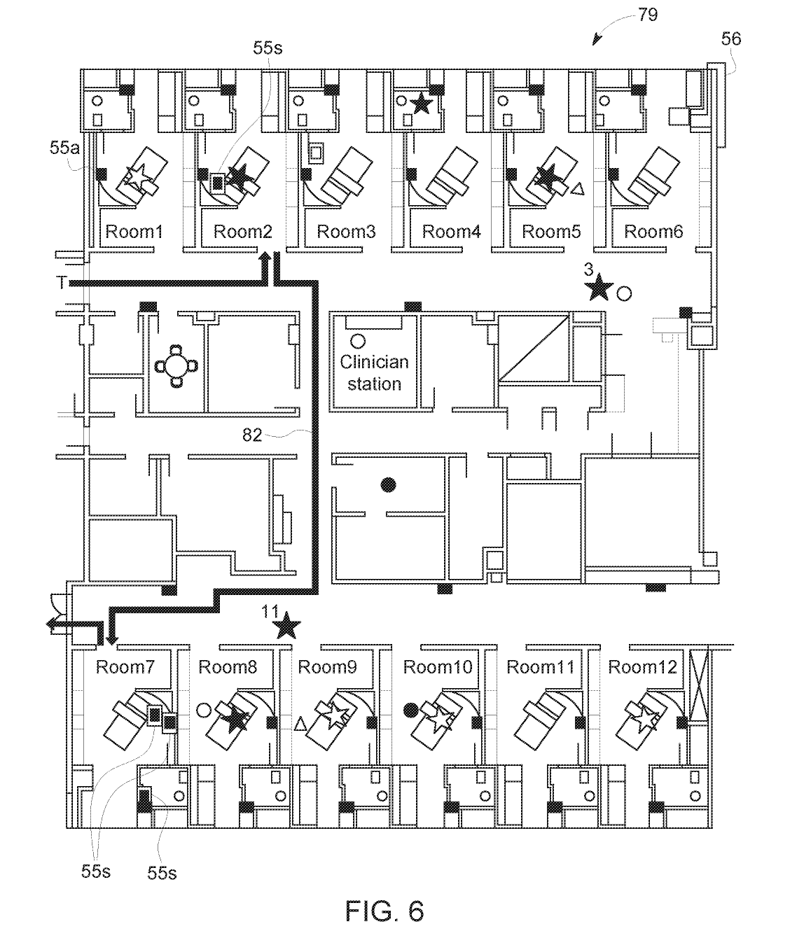

In other embodiments, the mapping module 24 may be configured to provide information regarding the locations of devices, and to determine and provide an optimal service route based on the device locations 67 of those devices that have been identified as needing service. For example, the mapping module 24 may receive a list or other indicator of devices in need of service, such as battery replacement, routine maintenance, or cleaning, and may locate those devices needing service on the map 79 of the care facility. The mapping module 24 may then determine an optimal service route for a technician based on the technician's starting point and the device locations 67 of the devices in need of service. The optimal service route may then be displayed to a technician by displaying a service route indicator on the map 79 of the care facility. FIG. 6 provides one example of such a map 79 having device location indicators 55s locating devices in need of service. A service route indicator 82 is presented on the map connecting the clinician location indicator T to the various patient rooms containing devices in need of service. Thereby, the technician time can be optimized and devices can be effectively maintained and serviced in an effective way.

The mapping module 24 is a set of software instructions executed on one or more processors within the patient monitoring system 1. In various embodiments, the mapping module 24 may be stored and executed within a computing system 235 of the host network 30. Alternatively or additionally, the mapping module 24 may be contained locally within the physiological monitoring system attached to or associated with the patient. For example, the mapping module 24 may be stored in and executed by a computing system 135 within the hub 15 and/or in one or more of the sensing devices 3a-3c. Further, in certain embodiments, the mapping module 24 may be provided in multiple devices within the system 1, such as to carry out various aspects or steps of the methods described herein. In the embodiment of FIG. 1, the mapping module 24 is comprised of instructions contained in and executed by both the computing system 235 of the host network 30 and the computing system 135 of the hub 15. Specifically, mapping module portion 24a is stored within the storage system of the computing system 235, and mapping module portion 24b is stored within the storage system 141 of the computing system 135. Together, the mapping module portions 24a, 24b execute instructions to determine the patient location indicator 54 based on the patient location in the care facility and/or other considerations, as described herein. In other embodiments, the mapping module 24 may be entirely contained in either the computing system 235 of the host network 30 or the computing system 135 of the hub 15.

For example, in one embodiment the mapping module portion 24a in the host network may receive the patient location from the location tracking module 22 and determine the patient location indicator 54, clinician location indicator 76, 77, and/or a map 79 providing such location indicators. The patient location indicator 54, clinician location indicator 76, 77, and/or a map 79 providing such location indicators may then be communicated to the hub 15 via the communication link 28 between receiver/transmitter 31 of the host network 30 and receiver/transmitter 29 of the hub 15. Such wireless communications may be conducted according to any of various wireless means, as is described above. In certain embodiments, the mapping module portion 24a may instruct the host network 30 to publish the patient location indicator 54, the clinician location indicator 76, 77, and/or a map 79 with such location indicators, which may then be accessed by the hub 15 and/or the clinician device 70 according to their own routines and timing. For example, communication of the locations 66-69 of various individuals and devices in the care facility from the host network 30 to the hub 15 may be via a publish-subscribe messaging pattern, or model. In such an embodiment, the host network 30 publishes information, and the hub 15 and/or the clinician device 70 subscribe to the published “messages” from the mapping module 24. Accordingly, the host network 30 does not need to establish a direct communication link with the hub 15 or the clinician device, and vice versa, and each can continue to operate normally regardless of the other.

FIG. 3 schematically depicts one embodiment of computing system 235 of the host network 30. The exemplary computing system 235 includes the mapping module 24 the location tracking module 22 for determining the patient location 68, and the central monitoring module 25 that cooperates with the monitoring regulation module 23 to generate location indicators 54-55, 75-77 for the patient 4, which each function variously as described herein. The computing system 235 generally includes a processing system 219, storage system 221, software 237, communication interface 239. The processing system 219 loads and executes software 237 from the storage system 221, including the location tracking module 22, the mapping module 24, and the central monitoring module 25, which are applications within the software 237. Each of the modules 22, 24, 25 include computer-readable instructions that, when executed by the computing system 235 (including the processing system 219), direct the processing system 219 to operate as described in herein in further detail, including to execute the steps to determine a patient location 68 and the patient location indicator 54.

Although the computing system 235 as depicted in FIG. 3 includes one software 237 encapsulating one location tracking module 22, the mapping module 24, and the central monitoring module 25, it should be understood that one or more software elements having one or more modules may provide the same operation. For example, the modules 22, 24, 25 may be combined into a shared set of instructions carrying out the steps described herein, or may be divided into any number of modules, which may be stored on separate storage devices and executed by different processing systems. Similarly, while description as provided herein refers to a computing system 235 and a processing system 219, it is to be recognized that implementations of such systems can be performed using one or more processors, which may be communicatively connected, and such implementations are considered to be within the scope of the description. For example, the computing system 235 may represent a cloud computing system and application implemented across multiple networked processing and storage devices.

The processing system 219 may include any one or more processing devices, such as one or more microprocessors, general purpose central processing units, application-specific processors, microcontrollers, or any other type of logic-based devices. The processing system 219 may also include circuitry that retrieves and executes software 237 from storage system 221. Processing system 219 can be implemented within a single processing device but can also be distributed across multiple processing devices or sub-systems that cooperate in executing program instructions, such as in the cloud-computing application described above.

The storage system 221, which includes the patient medical record database 33, can comprise any storage media, or group of storage media, readable by processing system 219, and capable of storing software 237. The storage system 221 can include volatile and non-volatile, removable and non-removable media implemented in any method or technology for storage of information, such as computer-readable instructions, data structures, program modules, or other data. Storage system 221 can be implemented as a single storage device but may also be implemented across multiple storage devices or sub-systems. For example, the software 237 may be stored on a separate storage device than the medical record database 33. Likewise, medical record database 33 can be stored, distributed, and/or implemented across one or more storage media or group of storage medias. Similarly, medical record database 33 may encompass multiple different sub-databases at different storage locations and/or containing different information which may be stored in different formats. Storage system 221 can further include additional elements, such a controller capable of communicating with the processing system 219.

Examples of storage media include random access memory, read only memory, optical discs, flash memory, virtual memory, and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. Likewise, the storage media may be housed locally with the processing system 219, or may be distributed in one or more servers, which may be at multiple locations and networked, such as in cloud computing applications and systems. In some implementations, the storage media can be a non-transitory storage media. In some implementations, at least a portion of the storage media may be transitory.

The communication interface 239 interfaces between the elements within the computing system 235 and external devices, such as various receiver/transmitters 31, 34a-34n that receive and transmit information to and from the host network 30. For example, the communication interface may operate to receive patient identifiers 61, clinician identifiers 60, visitor identifiers 59, and device identifiers 58, and the corresponding receiver identifications 62 (providing the identification receiver 46a, 46n that received the identifier(s)) generated via the location tracking system 40, receive position indicator(s) 63 and motion indicator(s) 65 from the hub 15 and/or directly from one or more of the sensing devices 3a-3c. The communication interface may further facilitate transmission of the patient location 68 and the location indicators 54-55, 75-77 and the map 79 of the care facility containing those location indicators.

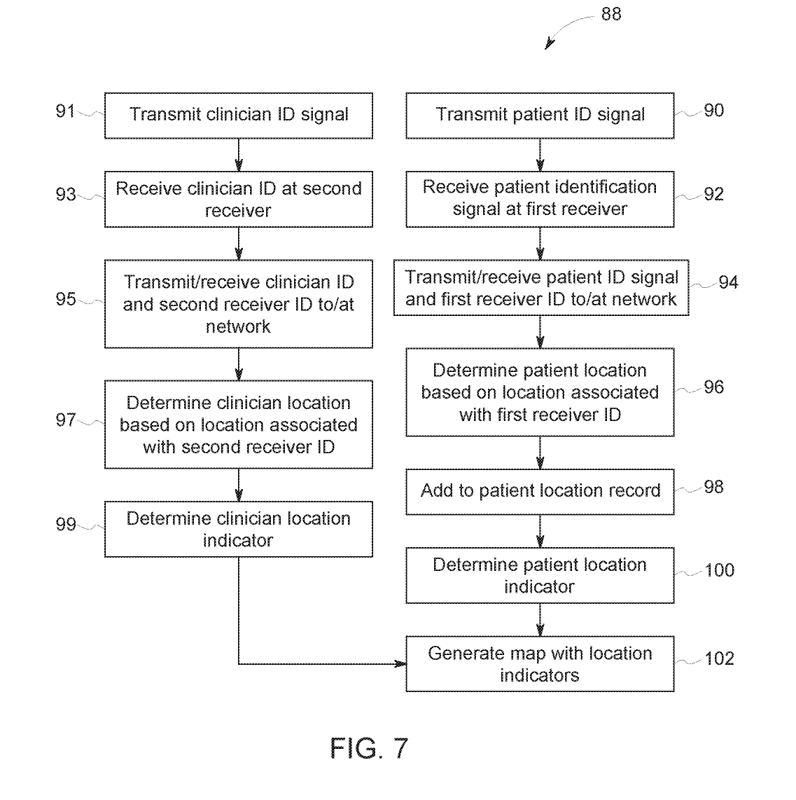

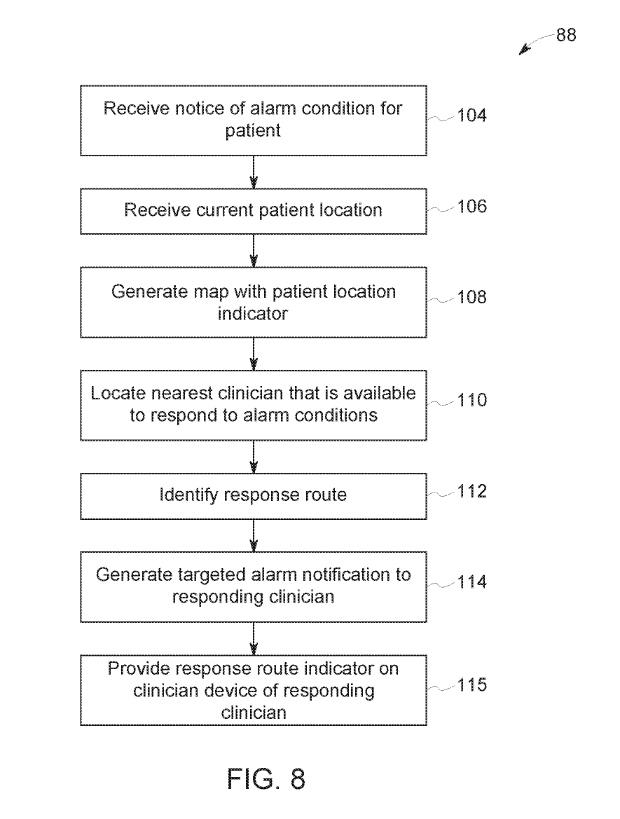

FIGS. 7 and 8 depict various embodiments and aspects of a method 88 of monitoring a patient. In the embodiment depicted in FIG. 7, a patient identifier is transmitted at step 90 and received by a first identification receiver at step 92. The patient identifier and first receiver identification are then transmitted to and received at the host network, represented at step 94. The patient location is then determined at step 96 based on the location associated with the first receiver identification and based on the patient associated with the patient identifier. The patient location is recorded in a patient location record at step 98, such as in the patient medical record in the medical records database 33. A patient location indicator is then determined at step 100 based on the patient location, and may further be based on the position and/or motion indicator(s) determined based on input from activity sensor(s) 8 attached to the patient and/or based on physiologic parameter data recorded from the patient.

Similarly, a clinician identifier is transmitted at step 91 and received by a second identification receiver at step 93. The clinician identifier and second receiver identification are then transmitted to and received at the host network, represented at step 95. The clinician location is then determined at step 97 based on the location associated with the second receiver identification and based on the clinician associated with the clinician identifier. A clinician location indicator is then determined based on the clinician location, and/or based on the clinician availability indicator 64. A map is then generated at step 102 including the location indicators for all of the patients and clinicians in a care facility.

FIG. 8 is a flow chart exemplifying another aspect or embodiment of a method 88 of monitoring a patient. Notice of an alarm condition for a patient is received at step 104 and the current patient location for that patient is received at step 106. A map with a patient location indicator composed thereon is generated at step 108. At step 110, the nearest clinician is located that is available to respond to the alarm condition. A response route is then identified at step 112, which is the route on the map between the clinician location and the patient location. A targeted alarm notification is then generated at step 114 to notify the responding clinician of the alarm condition. For example, the targeted alarm notification may be generated at the clinician device associated with the responding clinician. A map providing a response route indicator 81 is then provided to the clinician, such as via the clinician device 70, which may be either an auditory direction que or a map pictorially representing the response route on the map of the care facility, such as that depicted in FIG. 5.

This written description uses examples to disclose the invention, including the best mode, and also to enable any person skilled in the art to make and use the invention. Certain terms have been used for brevity, clarity and understanding. No unnecessary limitations are to be inferred therefrom beyond the requirement of the prior art because such terms are used for descriptive purposes only and are intended to be broadly construed. The patentable scope of the invention is defined by the claims, and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

We claim:

1. A patient monitoring system comprising:
one or more patient identification transmitters that each transmit a patient identifier, wherein each patient identifier is associated with a patient;
one or more clinician identification transmitters that each transmit a clinician identifier, wherein each clinician identifier is associated with a clinician;
a location tracking system having a plurality of identification receivers arranged in a care facility to receive the patient identifiers and the clinician identifiers;
wherein the location tracking system determines a patient location within the care facility for each patient identification transmitter based on a location of receipt of the patient identifier, and determines a clinician location within the care facility for each clinician identification transmitter based on a location of receipt of the clinician identifier;
a mapping module executable to:
access a map of the care facility;
receive the patient locations and the clinician locations;
locate the patient locations and the clinician locations on the map of the care facility;
display a patient location indicator on the map of the care facility identifying each patient location; and
display a clinician location indicator on the map of the care facility identifying each clinician location.

2. The patient monitoring system of claim 1, further comprising:
an activity sensor attached to each patient measuring at least one of a position and a motion; and
an activity analysis module that determines at least one of a motion indicator or a position indicator for the respective patient based on measurements by the activity sensor;
wherein each patient location indicator further identifies the motion indicator and/or the position indicator for the respective patient.

3. The patient monitoring system of claim 2, further comprising a sensing device configured to measure a heart rate of the patient; and
wherein the patient location indicator further indicates heart rate information.

4. The patient monitoring system of claim 2, further comprising:
a sensing device associated with each patient configured to measure physiologic parameter data therefrom and detect an alarm condition for the respective patient based on the physiologic parameter data.

5. The patient monitoring system of claim 4, wherein the patient location indicator for the respective patient further identifies the alarm condition.

6. The patient monitoring system of claim 4, wherein the mapping module is further executable to identify a responding clinician to respond to the alarm condition based on the respective patient location of the alarm condition and the clinician locations.

7. The patient monitoring system of claim 6, wherein the mapping module is further executable to generate a targeted alarm notification to a clinician device associated with the responding clinician.

8. The patient monitoring system of claim 7, wherein the mapping module is further executable to:
identify a response route between the respective patient location and the clinician location of the responding clinician;
wherein the targeted alarm notification includes displaying a response route indicator depicting the response route on the map of the care facility.

9. The patient monitoring system of claim 1, further comprising:
one or more device transmitters that each transmit a device identifier associated with a device, and wherein the location tracking system receives the device identifiers and determines a device location within the care facility for each device identification transmitter based on a location of receipt of the respective device identifier; and
wherein the mapping module is further executable to:
receive the device location; and
display a device location indicator on the map of the care facility identifying each device location.

10. The patient monitoring system of claim 7, wherein the mapping module is further executable to:
determine an optimal service route based on the device locations;
display a service route indicator depicting the optimal service route on the map of the care facility.

11. The patient monitoring system of claim 1, further comprising:
at least one visitor identification transmitter that transmits a visitor identifier associated with a visitor, and wherein the location tracking system receives the visitor identifier and determines a visitor location within the care facility based on a location of receipt of the visitor identifier; and
wherein the mapping module is further executable to:
receive the visitor location; and
display a visitor location indicator on the map of the care facility identifying each visitor location.

12. A method of patient monitoring, the method comprising:
transmitting a patient identifier associated with a patient from a patient identification transmitter;
transmitting a clinician identifier associated with a clinician from a clinician identification transmitter;
receiving the patient identifier at a first identification receiver at a first known location;
determining a patient location within the care facility based on the first known location of the first identification receiver;
receiving the clinician identifier at a second identification receiver at a second known location;
determining a clinician location within the care facility based on the second known location of the second identification receiver;
accessing a map of the care facility;
receiving the patient location and the clinician location;
locating the patient location and the clinician location on the map of the care facility;
displaying on a display a patient location indicator on the map of the care facility identifying the patient location; and
displaying on a display a clinician location indicator on the map of the care facility identifying the clinician location.

13. The method of claim 12, further comprising:
measuring at least one of a position and a motion of the patient; and
determining at least one of a motion indicator or a position indicator;
wherein the patient location indicator displayed on the map of the care facility further identifies the motion indicator and/or the position indicator for the respective patient.

14. The method of claim 13, further comprising measuring at least one of a position and a motion of the patient with at least two activity sensors attached to the patient, each activity sensor comprising at least one of an accelerometer and a gyroscope.

15. The method of claim 14, measuring a heart rate of the patient; and
wherein the patient location indicator displayed on the map of the care facility further indicates heart rate information.

16. The method of claim 12, further comprising:
measuring a physiologic parameter data from the patient;
detecting an alarm condition for the patient based on the physiologic parameter data; and
identifying a responding clinician to respond to the alarm condition based on the patient location and a plurality of clinician locations of clinicians in the care facility.

17. The method of claim 16, wherein the patient location indicator displayed on the map of the care facility further identifies the alarm condition.

18. The method of claim 16, further comprising generating a targeted alarm notification to a clinician device associated with the responding clinician.

19. The method of claim 17, further comprising identifying a response route between the respective patient location displayed on the map of the care facility and the clinician location of the responding clinician;
wherein the targeted alarm notification includes displaying a response route indicator depicting the response route on the map of the care facility.

20. The method of claim 12, further comprising receiving a visitor location in the care facility;
displaying a visitor location indicator on the map of the care facility identifying the visitor location
